(19) United States
(12) Patent Application Publication
(10) Pub. No.: US 2017/0134652 A1
(43) Pub. Date: May 11, 2017

(54) VIEWPORT FOR IMAGING IN AN RF/MICROWAVE ENVIRONMENT

(71) Applicant: L-3 COMMUNICATIONS CORPORATION, San Carlos, CA (US)

(72) Inventor: John Charles CIPOLLA, Montoursville, PA (US)

(21) Appl. No.: 14/934,558

(22) Filed: Nov. 6, 2015

(51) Int. Cl. H04N 5/232; H04N 5/225; H05B 6/64

(52) U.S. Cl. CPC H04N 5/23241; H05B 6/6402; H05B 6/6432; H05B 6/6447; H04N 5/2252

(57) ABSTRACT

A system and method is provided for imaging an object while the object is being heated inside an RF environment. Preferred embodiments of the present invention operate in accordance with an RF device that includes an energy source and a housing having an aperture. A viewing port is attached to the housing, allowing an imaging device to image the object while it is being heated. The viewing port further includes an RF suppressor and an air purge system for cooling various components and/or reducing condensation on at least the lens portion of the imaging device.

### BACKGROUND OF THE INVENTION

1. Field of the Invention

The present invention relates to an RF/microwave apparatus, or more particularly, to a system and method for imaging an object while the object is being heated inside an RF/microwave environment.

2. Description of Related Art

Radio frequency (RF)/microwave devices are used in many applications, including industrial and home use. In home applications, low-power microwave ovens are used to cook and warm food, and in industrial applications, high-power RF/microwave ovens are used to heat various substances (e.g., chemical polymers, food ingredients, nutraceuticals, biotech products, pharmaceuticals, etc.).

Regardless of the type of RF device being used, or the type of substance being heated, there may be a need to watch (or monitor) the substance while it's being heated. For example, it may be advantageous for the user to stop heating the substance once the substance begins to melted, or to adjust the power level to ensure that the substance is being heated evenly, or uniformly. To this end, certain RF devices include a window, allowing the user to observe the substance while it is being heated. However, in industrial application, where high-power devices are used, viewing the substance (i.e., seeing the substance at visible wavelengths) does not often provide valuable data. Also, windows may be ineffective due to steam that's produced during the heating process. Often an observer cannot see more than two to three feet in the RF chamber due to steam and condensation on the window. And even in home applications, where steam is generally not an issue, there is no way to tell by merely looking at the food, whether it is being cooked or heated evenly. For example, it is not uncommon for food being heated up in a microwave oven to be only partially heated (e.g., warm on the outside but cold in the center).

Thus, it would be advantageous to have a system and method that images a substance while the substance is being heated. In doing so, it may be beneficial to thermally image the substance, thereby allowing the substance to be viewed regardless of optical interference, such as steam, and to ensure that the substance is being heated evenly. Such a system can be used to not only determine whether the substance is being heated evenly, but also to give the operator actual temperature values. If it is determined that the substance is not being processed to desired ramp rates or profiles, then various factors (e.g., substance location, power level, belt speed, oven geometry, etc.) can be adjusted. Such a system, which may include a monitor (e.g., LCD), may allow the operator to observe surface temperatures, or a thermal image of the substance while it is being heated. The monitor may produce visual and/or thermal IR images (from at least one camera), and, in one embodiment, may replace the commonly engineered window/grid, which presently suppresses microwave radiation in at least home microwave ovens.

### SUMMARY OF THE INVENTION

The present invention provides a system and method for imaging an object while the object is being heated inside an RF/microwave apparatus. Preferred embodiments of the present invention operate in accordance with an RF/microwave device that includes a power supply, an RF/microwave energy source (e.g., magnetron, waveguide, etc.) for generating RF energy, and a controller for controlling operation of the RF/microwave energy source.

In one embodiment of the present invention, the RF/microwave device further includes a housing that includes an inner cavity for supporting an object that is being heated by the RF/microwave energy source (e.g., food ingredients, biotech products, etc.), and an aperture that allows an imaging device to image the object while it is being heated.

In a preferred embodiment of the present invention, the system further includes a viewing port, which allows an imaging device to be attached to the RF/microwave device. The viewing port is preferably in physical communication with the housing. This may be achieved by bolting or riveting the viewing port to the housing (e.g., near or around the aperture), and/or by placing a lip portion of the viewing port inside the aperture. With respect to the latter, the lip may have an outer perimeter and an inner perimeter, wherein the outer perimeter is substantially the same size as the aperture, thereby allowing the lip to be secured inside the aperture (e.g., via friction, via a bevel on the lip that “snaps” into place once the lip is inserted into the aperture, etc.). In this embodiment, the inner perimeter of the lip defines an inner opening in the viewing port, which allows an imaging device to visually and/or thermally image the object while it is being heated.

In one embodiment of the present invention, the imaging device includes a lens and a surrounding structure (e.g., a lens housing), wherein the circumference of the surrounding structure is substantially the same as the inner opening of the viewing port. By doing this, the imaging device can be secured to the RF/microwave device via the viewing port. For example, using known techniques, the imaging device can be “snapped” into place inside the viewing port, and the viewing port can be “snapped” into place inside the aperture in the housing, securing the entire assembly. In the alternative, other securing methods generally known to those skilled in the art (e.g., bolts, rivets, etc.) can also (or alternatively) be used to secure the imaging device to the housing, either directly or via the viewing port. This scheme provides operators with a thermal imager that is either fixed, or can be moved from one industrial chamber to another.

The viewing port may further includes at least one RF suppressor (discussed below), at least one inlet that is connected to an air source (e.g., a fan inside the RF/microwave device, a fan external to the RF/microwave device, a compressed air source, etc.), and at least one outlet, which allows the air to flow across at least a portion of the RF suppressor and at least a portion of the imaging device. By allowing air to flow in this fashion, not only is the RF suppressor and the imaging device cooled, but the air prevents or reduces condensation that may otherwise collect as a result of steam (e.g., steam emanating from the heated object). This is important because heat and/or condensation can interfere with the imaging device's ability to function properly. In this embodiment, the air may be received via at least one inlet, circulated through an internal annular passage, and exhausted via at least one outlet (e.g., at least one “air knife”).

As previously discussed, in an effort to prevent radiation leakage, the viewing port may further include an RF suppressor. For example, the viewing port may include a grid mesh constructed in known fashion to short out longitudinal RF wall currents in the RF energy. Such a grid mesh is similar to the mesh commonly used in windowed portions of microwave ovens designed for home use. In the present invention, the grid mesh functions to prevent or reduce radiation that would otherwise leak (e.g., through an inner opening of the viewing port). In an alternate embodiment of the present invention, a dielectric material, such as ferrite, can also be used to suppress RF leakage. This may be accomplished by placing the dielectric material around the aperture, around the inner opening of the viewing port, or any other location that results in the suppression of RF leakage.

A more complete understanding of a system and method for imaging an object while the object is being heated inside an RF/microwave device will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIG. 1 illustrates an RF/microwave device in accordance with one embodiment of the present invention;

FIG. 2 illustrates a back side of the RF/microwave device depicted hi FIG. 1;

FIGS. 3A and B illustrate a viewing port in accordance with one embodiment of the present invention, wherein the viewing port is configured to be mounted around or within an aperture of the RF/microwave device depicted in FIG. 2;

FIG. 4 illustrates the viewing port depicted in FIG. 3A attached to the RF/microwave device depicted in FIG. 2;

FIGS. 5A and B illustrate an imaging device in accordance with one embodiment of the present invention, wherein the imaging device is configured to image an object while the object is being heated inside the RF/microwave apparatus depicted in FIG. 1;

FIGS. 6A, B, C, and D illustrate different perspectives of the viewing port in accordance with certain embodiments of the present invention;

FIG. 7 provides a method of imaging an object while the object is being heated inside an RF/microwave device;

FIG. 8 illustrates an RF/microwave device in accordance with another embodiment of the present invention; and

FIG. 9 illustrates an RF/microwave device in accordance with another embodiment of the present invention.

### DETAILED DESCRIPTION OF THE PREFERRED EMBODIMENT

The present invention provides a system and method for imaging an object while the object is being heated inside a radio frequency (RF)/microwave device. In the detailed description that follows, like element numerals are used to describe like elements illustrated in one or more figures. It should be appreciated that while particular RF/microwave devices are discussed herein, and depicted in the drawings, the present invention is not limited to any particular RF or microwave device. The present invention is directed toward an imaging system that can be used in conjunction with any type of heating apparatus. Thus, the use of the term “RF apparatus” or “microwave apparatus” is used herein in its broad sense to encompass any device that uses RF (or microwave) energy to heat at least one object.

Preferred embodiments of the present invention operates in accordance with an RF/microwave device that includes (i) a housing, (ii) a power supply, (iii) an RF/microwave energy source (e.g., magnetron, waveguide, etc.), which functions to generate RF energy that can be used to heat an object located inside the housing, and (iv) a controller. The controller functions to at least control operation of the RF/microwave energy source. The controller (or another processing device) may also function to determine (e.g., based on thermal processing) whether the object is being heated evenly, and to automatically alter certain factors (e.g., power level, rotational direction and/or speed, etc.) to provide a more uniform heating process.

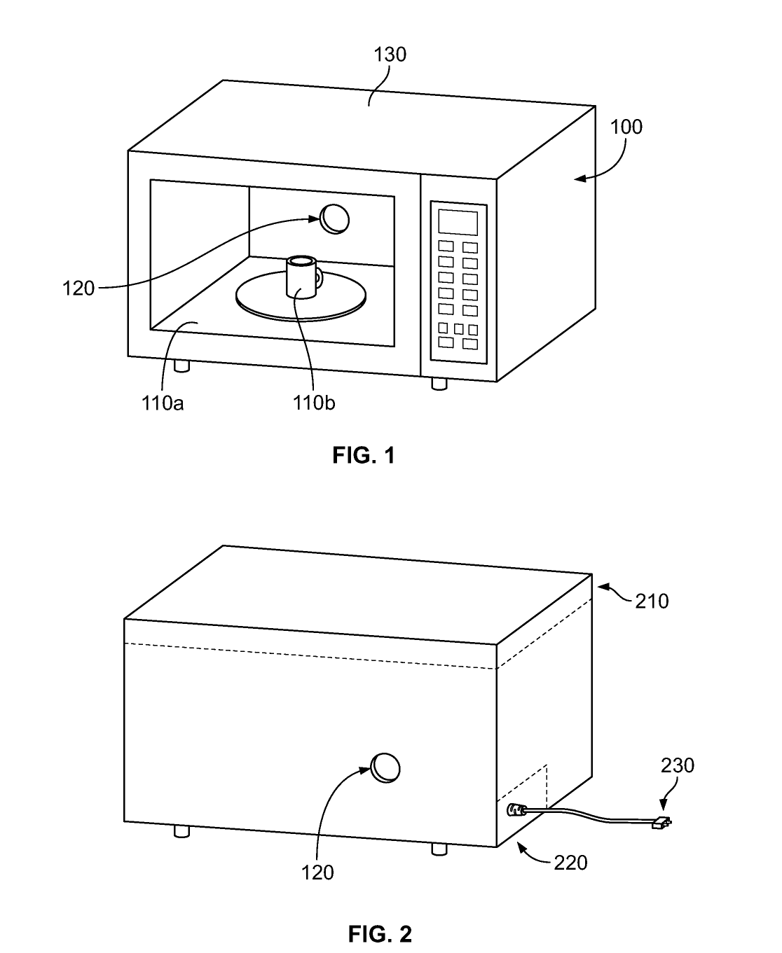

As shown in FIGS. 1 and 2, the RF/microwave device 100 includes at least one housing 130. While the housing 130 may include multiple layers, e.g., a metal outer layer, a non-metallic inner layer, etc., it preferably includes an inner cavity 110a for supporting at least one object 110b (e.g., food ingredients, biotech products, etc.), a power supply 220, 230, an RF/microwave energy source 210, and a controller (not shown) for controlling operation of at least the RF/microwave energy source 210. Preferably, the housing 130 also includes an aperture 120 that allows an imaging device (see, e.g., FIGS. 5A and B) to image the object 110b while it is being heated by the energy source 210. It should be appreciated that the RF/microwave devices discussed herein may include various other components, which are known to those skilled in the art, such as an interior light, a rotatable surface on the bottom inner cavity, etc. However, for brevity, such components are not shown in the attached figures.

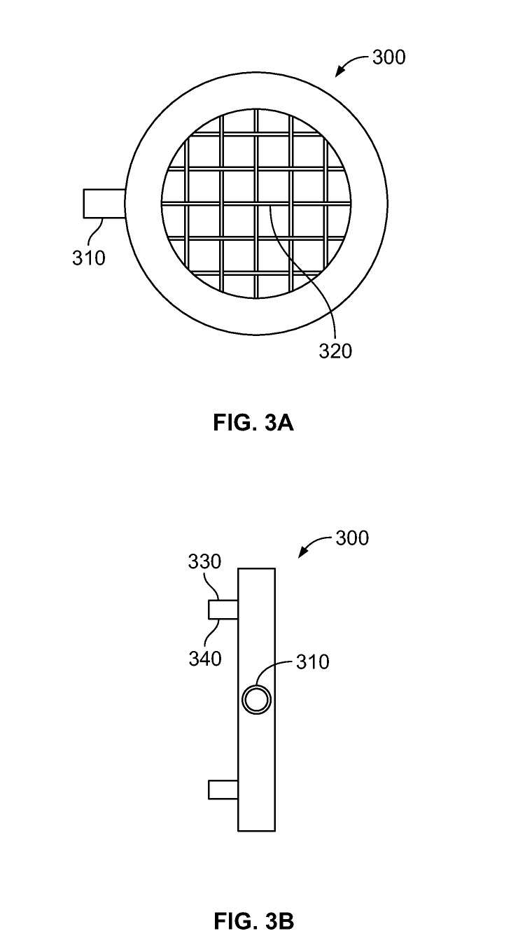

In a preferred embodiment of the present invention, the device further includes a viewing port, which allows an imaging device (see FIGS. 5A and B) to be mounted to the RF/microwave device (see FIG. 2). For example, as shown in FIGS. 3A and B, the viewing port 300 is configured to be in physical communication with the housing 130 (see FIG. 1). For example, the viewing port 300 may include a lip having an outer surface 330 and an inner surface 340, wherein the outer surface 330 (e.g., defining an outer perimeter of the lip) is substantially the same size as the aperture 120, thereby allowing the lip portion of the viewing port 300 to be mounted inside the aperture 120. In this embodiment, the inner surface 340 of the lip defines an inner opening in the viewing port (e.g., an aperture in the viewing port) that allows the imaging device (see FIGS. 5A and B) to visually and/or thermally image the object while it is being heated.

For example, as shown in FIGS. 5A and B, the viewing port should allow (or at least not inhibit) an imaging device 500 from imaging the object (FIG. 1, 110b) while it is being heated. In one embodiment of the present invention, the imaging device 500 includes a lens 520 and a surrounding structure 520 (e.g., a lens housing), where the circumference of the surrounding structure 520 is substantially the same as the inner opening of the viewing port. By doing this, the imaging device can be secured to the RF/microwave device via the viewing port.

It should be appreciated, however, that the present invention is not limited to an imaging device of similar size to the viewing port. In fact, it may be advantageous for the imaging device to include a lens and a surrounding structure that are substantially smaller than the inner opening, thereby allowing the imaging device to be angled to properly view the object being heated (given that different objects may require different viewing angles). Thus, a system that includes a viewing port and/or imaging device angled in a downward direction (allowing a substance boated on a lower surface of an inner cavity 110a of the RF/microwave device to be imaged) is within the spirit and scope of the present invention.

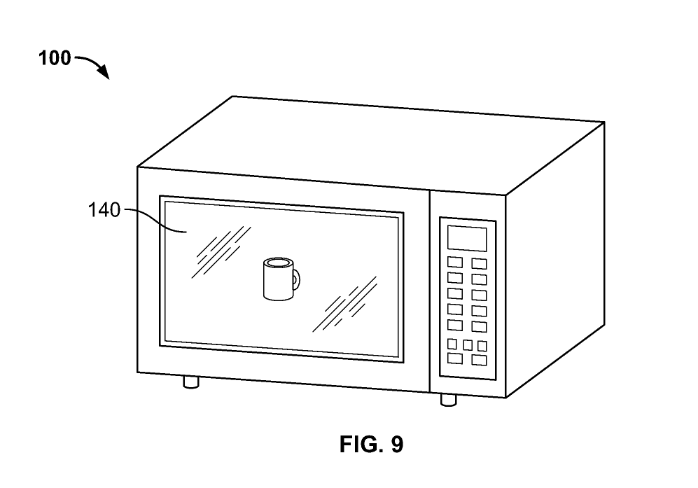

It should also be appreciated that the present invention is not limited to any particular type of imaging device. Thus, the use of any imaging device (e.g., an optical imaging device, a thermal imaging device, etc.), or any number of imaging devices (e.g., both an optical and a thermal imaging device, which may require more than one aperture, more than one viewing port, and the blending of multiple images), is within the spirit and scope of the present invention. It should also be appreciated that the imaging device may be configured to store image data (as acquired) in a memory device (e.g., allowing it to be processed by the controller), to provide the image data to a remote display (e.g., via hard wire or Wi-Fi), or to provide the image data to a display in physical communication with the RF/microwave device (e.g., allowing a user to view the object being heated on a display on the face of the RF/microwave device). For example, as shown in FIG. 9, an LCD display 140 may be added to the RF/microwave device 100 (e.g., by replacing all or a portion of the conventional windowed portion of the RF/microwave device with an LCD), thereby allowing an operator to view (optically and/or thermally) the substance while it is being heated. Such an embodiment may not only allow an operator to see the substance while it is being heated (via an image of the substance on the LCD, similar to what one would normally see via visual wavelengths), but also provide the operator with thermal information on the object (e.g., as a separate image on the LCD, superimposed over the image on the LCD, etc.), thereby allowing the operator to ensure that the substance is being heated evenly. In this embodiment, the controller may also allow the operator to control how the substance is presented on the LCD (e.g., visual representation only, thermal representations only, both visual and thermal representation (as separate images or superimposed), etc.).

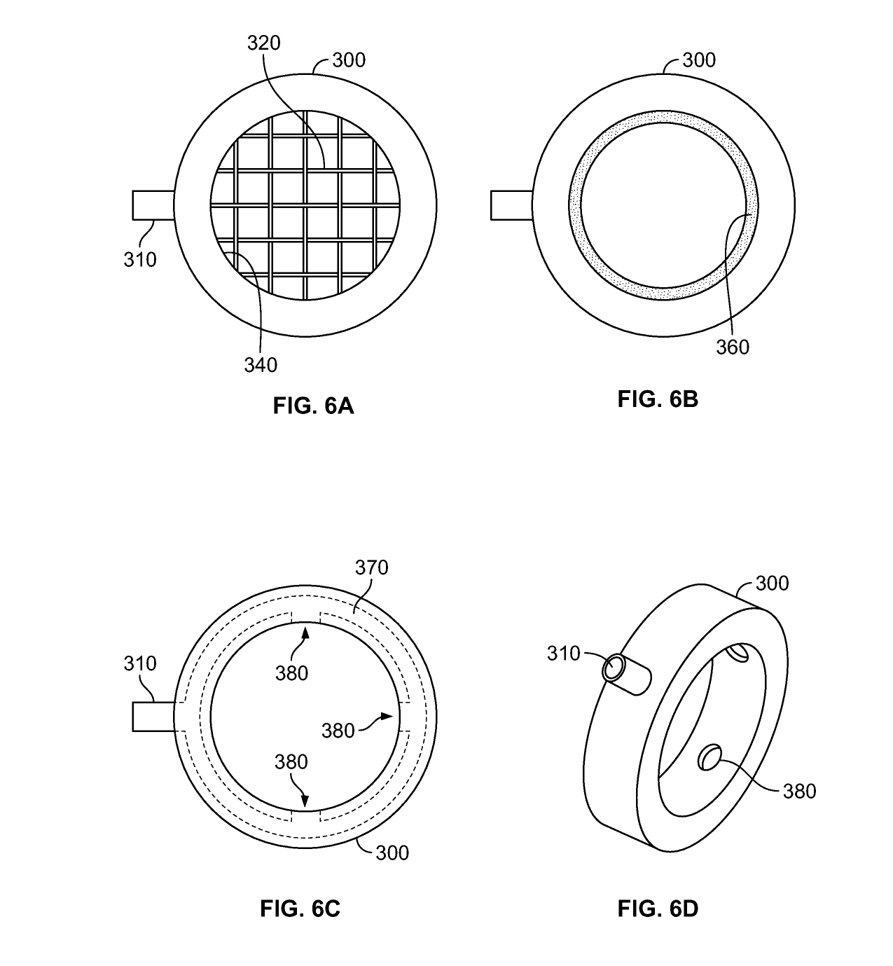

In one embodiment of the present invention, the viewing port 300 further includes an RF suppressor (discussed below), at least one inlet 310 that is connected to an air source (e.g., a fan inside the RF/microwave apparatus (e.g., a dedicated fan or a fan that is also used to circulate air inside the inner cavity of the RF/microwave device), a fan external to the RF/microwave device, a compressed air source, etc.), and at least one outlet (see, e.g., FIGS. 6C and D), which allows the air to flow across at least a portion of the RF suppressor and at least a portion of the imaging device. By allowing air to flow in this fashion, not only is the RF suppressor and the imaging device cooled (e.g., preventing/reducing the effects of heat (e.g., from the object being heated) on the RF suppressor and the imaging device), but it prevents/reduces condensation that may otherwise collect (e.g., as a result of steam emanating from the object being heated). This is important because heat and/or condensation can interfere with the imaging device's ability to properly view (optically and/or thermally) the object being heated.

As shown in FIGS. 6B and C, air may be received via at least one inlet 310. The air may then be circulated through an internal annular passage 370, and exhausted via a plurality of outlets 380. In one embodiment, the outlets may be what are commonly referred to as “air knifes,” allowing the air to be forcefully moved over at least portions of the RF suppressor and portions of the imaging device. It should be appreciated, that the present invention is not limited to the air purge system depicted and discussed herein, and any system that allows the RF suppressor and/or the lens portion of the imaging device to be cooled and/or to prevent condensation is within the spirit and scope of the present invention. Thus, the invention is not limited to any particular air source, any particular air intake(s), or any particular air distribution system, as long as certain ones of the foregoing objectives are achieved.

In an effort to prevent radiation leakage via the aperture and/or the viewing port, the viewing port may further include an RF suppressor. For example, as shown in FIG. 3A, the viewing port 300 may further include a grid mesh 320. The grid mesh 320 is constructed in known fashion to short out longitudinal RF wall currents in the RF energy. Such a grid mesh is similar to the mesh inserted in windowed portions of microwave ovens designed for home use. In short, the grid mesh 320 functions to prevent or reduce radiation that would otherwise leak through the viewing port, or the inner opening thereof.

In an alternate embodiment of the present invention, a dielectric material, such as ferrite, can also (or alternatively) be used to suppress RF leakage. For example, as shown in FIG. 6B, ferrite blending with silicon potting 360 can be used to absorb, or suppress, RE leakage. This can be done by placing the dielectric material around the aperture and/or around the inner opening in the viewing port (e.g., where radiation would other leak once the imaging device is in place). It should be appreciated, however, that the present invention is not limited to any particular type of dielectric material, or any particular location. Thus, the use of any dielectric material, positioned to suppress RF leakage (e.g., inside a resonant cavity, where components are mounted together, etc.) is within the spirit and scope of the present invention.

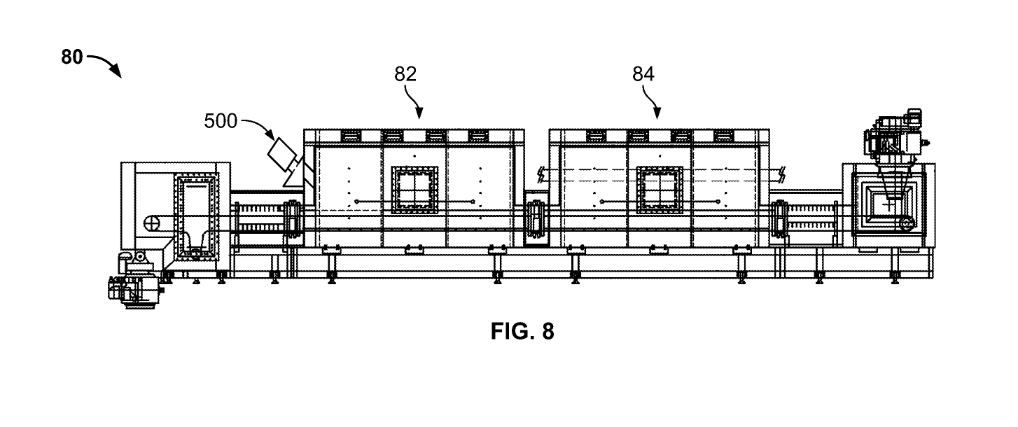

The advantages of using grid mesh, is that it functions well in high-powered RF devices (e.g., industrial environments). It also allows for an expensive imaging device (such as the type used in industrial environments) to be removed without exposing the user, the environment and/or the electronics to high (or unacceptable) levels of radiation. For example, as shown in FIG. 8, by using a grid mesh, an imaging device 500 can be moved (e.g., from a first chamber 82 to a second chamber 84), thereby allowing a single imaging device 500 to be used in conjunction with an RF/microwave device 80 that includes a plurality of processing chambers. In contradistinction, a dielectric material is perhaps better suited for low-powered RF device (e.g., home environments), where the imaging device is permanently mounted to the viewing port, and not intended for removal.

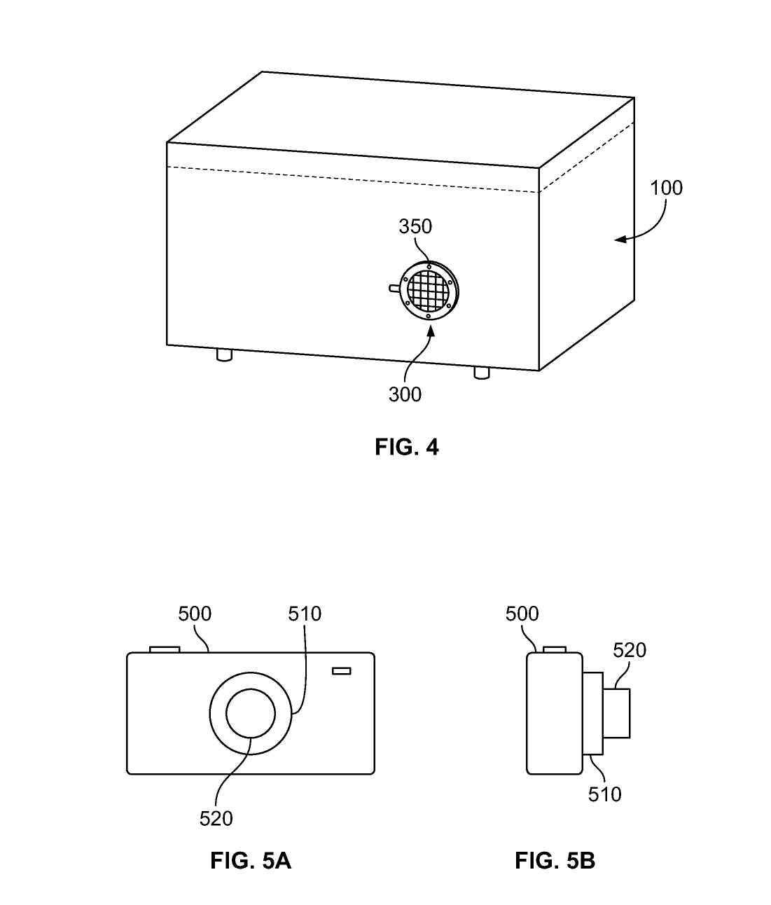

It should be appreciated that the present invention is not limited to the viewing port, as previously described. For example, as shown in FIG. 4, the viewing port may also, or alternatively, be connected to the RF/microwave device via a plurality of bolts or rivets 350. The viewing port may also comprise different structures, as long as the structures reduce or eliminate RF leakage via the aperture, allow (or do not inhibit) imaging of the object, and allow (or do not inhibit) use of an air purge system. Any such viewing port that functions in this manner is within the spirit and scope of the present invention.

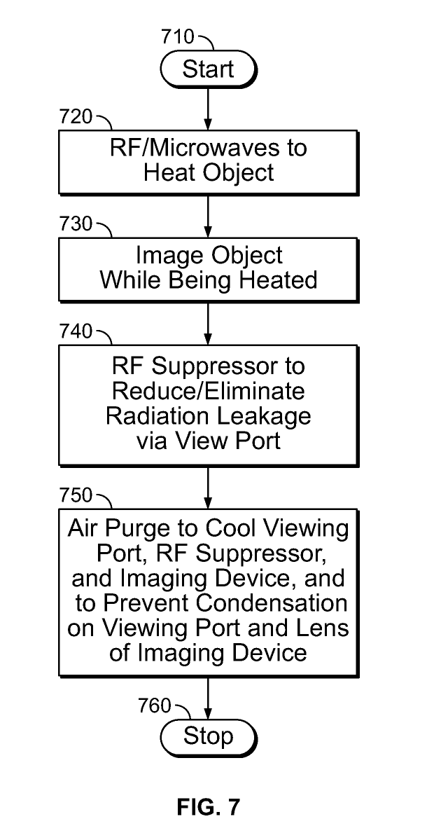

FIG. 7 illustrates a method of monitoring an object while it is being heated using RE energy. Starting at step 710, an RF/microwave source is used to generate RF energy at step 720, which can be used to heat an object located inside the RF/microwave device. An imaging device is then used to image the object while the object is being heated at step 730. In one embodiment of the present invention, the imaging device is situated to view the object via an aperture placed in the housing of the RF/microwave device. An RF suppressor is then used at step 740 to prevent or reduce radiation leakage via the aperture. Air is then moved across the RF suppressor and/or the lens portion of the imaging device at step 750, stopping the method at step 760. The purpose of step 750 is to cool at least a portion of the RE suppressor and/or at least a portion of the imaging device, and/or to prevent (or reduce) condensation on the same. It should be appreciated that the present invention is not limited to the method illustrated in FIG. 7, and may include additional, fewer, or differently arranged steps. For example, if the imaging device is placed inside the housing of the RF/microwave device, additional RF suppression may not be needed, and step 740 can be skipped.

Having thus described several embodiments of a system and method for imaging an object while the object is being heated inside an RF/microwave environment, it should be apparent to those skilled in the art that certain advantages of the system and method have been achieved. It should also be appreciated that various modifications, adaptations, and alternative embodiments thereof may be made within the scope and spirit of the present invention. The invention is solely defined by the following claims.

What is claimed is:

1. An apparatus for using radio frequency (RF) energy to heat at least one object and for imaging said at least one object, comprising:
at least one housing having an aperture and an inner cavity configured to support said at least one object;
a power supply;
an RF energy source connected to said power supply and configured to generate RF energy, said RF energy being used to heat said at least one object;
a controller for controlling operation of at least said RF energy source;
a viewing port in physical communication with said at least one housing, said viewing port comprising an inner opening and at least one RF suppressor for reducing leakage of RF energy from at least one of around or through said inner opening;
an imaging device in physical communication with said viewing port, said at least one imaging device being configured to image said at least one object through said inner opening while said at least one object is being heated; and
an air purge system for cooling at least a portion of said viewing port and for reducing condensation on a lens portion of said imaging device.

2. The apparatus of claim 1, wherein said RF suppressor comprises a grid mesh located within said inner opening and configured to at least short out portion of longitudinal wall currents in said RF energy.

3. The apparatus of claim 1, wherein said RF suppressor comprises a dielectric material positioned around at least one of said aperture and said inner opening, said dielectric material being configured to absorb portions of said RF energy.

4. The apparatus of claim 3, wherein said dielectric material is ferrite blended with silicon potting.

5. The apparatus of claim 1, wherein said imaging device comprises an optical imaging device.

6. The apparatus of claim 1, wherein said imaging device comprises an infrared (IR) imaging device.

7. The apparatus of claim 5, further comprising a second imaging device for imaging said at least one object while said at least one object is being heated, said second imaging device comprising an IR imaging device.

8. The apparatus of claim 1, further comprising at least one of a fan and compressed air to cool said at least said portion of said viewing port and for reducing condensation on said lens portion of said imaging device.

9. The apparatus of claim 8, wherein said air purge system comprises at least one net and at least one outlet, wherein said at least one of said fan and said compressed air is configured, at least in part, to move air into said at least one net and out of said at least one outlet, allowing said air to be moved over at least a portion of said viewing port and across said lens portion of said imaging device.

10. The apparatus of claim 9, wherein said viewing port includes an internal annular passage, said air being moved in said at least one inlet, through said internal annular passage, and out of said at least one outlet.

11. A method for imaging at least one object, said at least one object being heated using radio frequency (RF) energy, comprising:
using an RF energy source to heat said at least one object located within at least one housing, said at least one housing having an aperture;
using an imaging device to image said at least one object while said at least one object is being heated, wherein said imaging device is connected to said at least one housing via a viewing port that includes an inner opening and is in physical communication with said at least one housing;
using at least one RF suppressor for at least reducing leakage of RF energy from at least one of around and through said viewing port; and
operating an air purge system to cool at least a portion of said viewing port and for reducing condensation on a lens portion of said at least one imaging device.

12. The method of claim 11, wherein said step of using at least one RF suppressor further comprises using a grid mesh located within said inner opening of said viewing port.

13. The method of claim 11, wherein said step of using at least one RF suppressor further comprises using a dielectric material positioned around at least one of said aperture and said inner opening of said viewing port.

14. The method of claim 13, wherein said dielectric material comprises a ferrite blended with silicon potting.

15. The method of claim 11, wherein said imaging device comprises one of an optical imaging device and an infrared (IR) imaging device.

16. The method of claim 11, wherein said step of operating an air purge system further comprises using one of a fan and a compressed air to move air into an outer portion of said viewing port and out of an inner portion of said viewing port.

17. An apparatus for using RF/microwave energy to heat at least one object and for imaging said at least one object, comprising:
at least one housing having a windowed portion, an aperture, and an inner cavity configured to support said at least one object;
a power supply;
a magnetron for generating said RF/microwave energy, said RF/microwave energy being used to heat said at least one object;
a controller for controlling operation of at least said magnetron;
a port attached to said at least one housing, said port comprising an inner opening and a radiation suppressor for at least reducing radiation that passes at least one of around and through said port;
an imaging device in physical communication with said port, said imaging device comprising at least one of an optical imaging device and an infrared (IR) imaging device and being configured to image said at least one object via said inner opening while said at least one object is being heated; and
an air purge system for moving air over at least a portion of said port and a lens portion of said imaging device, said air purge system comprising at least a fan for moving said air over at least said portion of said port and said lens portion of said imaging device.

18. The apparatus of claim 17, wherein said radiation suppressor comprises a grid mesh located within said inner opening.

19. The apparatus of claim 17, wherein said radiation suppressor comprises a dielectric material positioned around at least one of said aperture and said inner opening.

20. The apparatus of claim 17, wherein said port includes an annular structure defining said inner opening and having an internal annular passage, said air being moved by said fan into an inlet portion of said port, through said internal annular passage, and out of an outlet portion of said port.
